(19) United States
(12) Patent Application Publication
(10) Pub. No.: US 2006/0148653 A1
(43) Pub. Date: Jul. 6, 2006

(54) Light weight carriers

(76) Inventors: William W. Keller, Batesville, AR (US); Lyn Kelley, Sulphur Rock, AR (US)

Correspondence Address: BLANK ROME LLP, 600 NEW HAMPSHIRE AVENUE, N.W., WASHINGTON, DC, 20037, US

(21) Appl. No.: 11/028,222

(22) Filed: Jan. 4, 2005

(51) Int. Cl. A01N 25/12; A01N 65/00

(52) U.S. Cl. 504/367; 424/405; 424/750

(57) ABSTRACT

The present invention relates to light weight carriers. Particularly, the present invention relates to carriers produced from rice hulls, calcium carbonate, and a binder. The light weight carriers are used primarily as absorbent materials, especially for carrying fertilizers, pesticides, herbicides, insecticides, rodenticides, and the like. The carrier of the present invention comprises rice hull, calcium carbonate, and a binding agent.

### FIELD OF THE INVENTION

The present invention relates to light weight carriers. Particularly, the present invention relates to carriers produced from rice hulls, calcium carbonate, and a binder. The light weight carriers are used primarily as absorbent materials, especially for carrying fertilizers, pesticides, herbicides, insecticides, rodenticides, and the like.

### BACKGROUND OF THE INVENTION

Cellulose materials are generally good absorbents, and are desirable because of their biodegradability. Cellulose materials, such as wood shavings or sawdust, rice hulls, corncobs, pecan shells and peanut shells can be processed to produce biodegradable carriers. U.S. Pat. No. 5,041,410 to Ivie, U.S. Pat. No. 5,062,954 to Leedy et al., U.S. Pat. No. 5,064,407 to Peiffer, and U.S. Pat. No. 5,207,389 to Hall et al. set forth processes for making absorbent products from these materials, with peanut hulls or corncobs being a preferred material.

Commercial rice processing operations today create large quantities of rice hulls. Rice hulls have a few low-value uses, such as a filter product and bedding material for chicken houses, but they mostly present a disposal problem. Because profitable uses of rice hulls have not been previously proven, a large percentage of the hulls have normally been disposed of by incineration which produces air borne pollutants, or by dumping which has problems of continuous accumulations.

However, rice hulls have the potential for profitable commercial use in other applications due to their chemical inertness which renders them suitable as carriers for pesticides and fertilizers. Their high liquid absorbing property also renders them potentially suitable for use in a number of industrial processes as absorbent agents.

Attempts at transforming cellulose materials into carriers suitable for use as chemical absorbents, i.e. as pesticide and fertilizer carriers, have been beset with problems. Foremost among these problems has been the inconsistent, uneven absorption and/or release of the chemical, and heavy weight. Therefore, there remains a need for a light weight carrier that has consistent and controllable absorption and release characteristics.

### SUMMARY OF THE INVENTION

The present invention provides a cost effective, light weight carrier for pesticide and herbicide having improved appearance, reduced pellet degradation from herbicide application, and better absorption during production while improving the release of herbicide and/or pesticide following application to the soil. Although pesticides and herbicides are preferably used with the carrier of the present invention, other chemicals and/or materials, such as, but not limited to, fertilizers, rodenticides, insecticides, and the like, are also appropriate. The carrier of the present invention is most preferred when used with chemicals and/or materials that are absorbed into and/or coated on the carrier and are released from the carrier upon final application.

The light weight carrier contains rice hulls, calcium carbonate, and a binding agent. Preferably, the rice hull is present in an amount of about 27-58% by weight; the calcium carbonate is present in an amount of about 27-67% by weight; and the binding agent is present in an amount of about 4-10% by weight. Most preferably, the rice hull is a 1:1 mixture of refined rice hull having a size of about 20-80mesh and ground rice hull having a size of about −80 mesh or less.

The carrier is used to absorb chemicals, such as pesticides and herbicides to be used in the field. Once released in the field the carrier releases the chemical in a sustained manner. Because of its light weight, the carrier of the present invention is suitable for spreading by air or conventional fertilizer applicators.

Methods of making the carrier are also disclosed. The methods involve mixing the rice hulls, calcium carbonate, and a binding agent; forming pellets out of the mixture, and drying the pellets.

### BRIEF DESCRIPTION OF THE DRAWINGS

FIG. 1 is a schematic drawing of a preferred process for making the present fertilizer.

### DETAILED DESCRIPTION OF THE PREFERRED EMBODIMENT

The light weight carrier of the present composition contains rice hulls, calcium carbonate, and a binder. The relative amounts of the components are preferably about 27-58% by weight of rice hulls, most preferably about 28-30%; about 27-67% by weight of calcium carbonate, most preferably about 64-66%; and about 4-10% by weight of the binding agent, most preferably about 6-8%.

The rice hull can be, but is not limited to, ground rice hull and/or refined rice hull. Refined rice hull preferably has a hull size of about 20-80mesh. Ground rice hull is rice hull that has been ground into a dust, preferably, having a particle size of about −80 mesh or less. In a preferred embodiment, the ground and refined rice hulls are used together, preferably in equal amounts, to form the carrier. Different ratios of refined rice hull and ground rice hull can be varied to achieve a desired density specified by the final user. Because ground rice hull has a higher density than refined rice hull, the portion of ground rice hull can be increased to make a final product with higher density. On the other hand, to make a low-density final product, the portion of refined rice hull can be increased.

The calcium carbonate adds calcium to the soil as a fertilizer, increases soil pH, and provides additional calcium for plants. In an embodiment, the calcium carbonate can be added in the form of dolomitic limestone. Dolomitic limestone is a commercially available agricultural product containing both calcium carbonate (about 54%) and magnesium carbonate (about 36%).

The binder is used to bind the fertilizer together to form pellets or granules. The preferred binder is calcium lignosulfonate in an aqueous solution of about 35-65%. Although calcium lignosulfonate is preferred, other binders, such as sodium lignosulfonate and molasses, are also appropriate for the present invention.

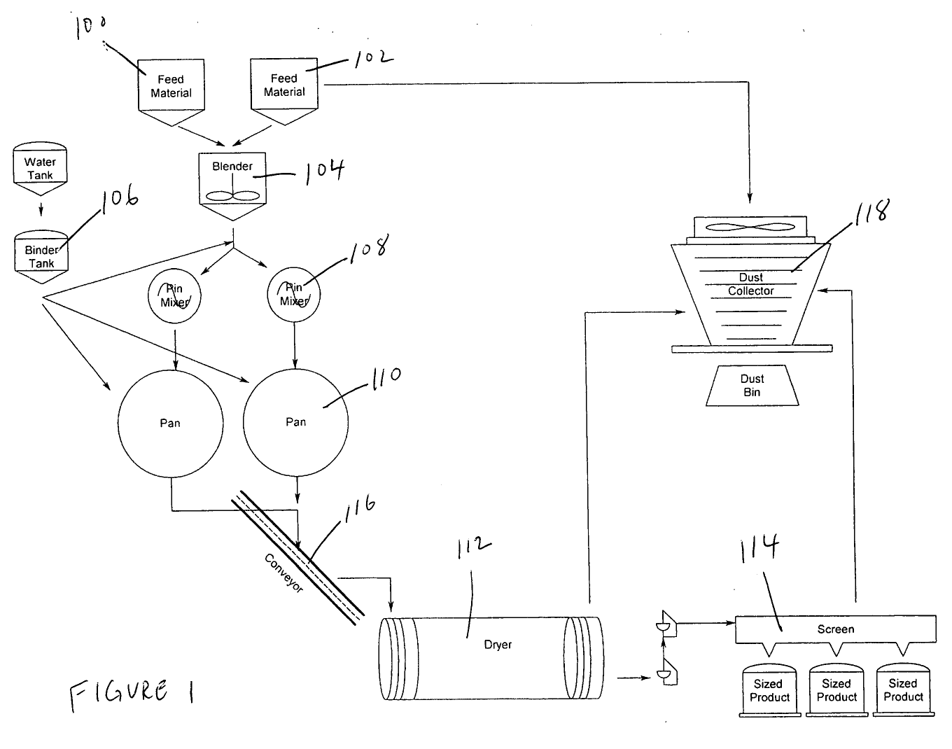

The light weight carrier of the present invention is made by mixing rice hull, calcium carbonate, and the binder together to form a homogeneous mixture. FIG. 1 shows a preferred process for making the carrier. The rice hull is stored in the first feed container 100; and the calcium carbonate is stored in the second feed container 102. Preferably, the rice hull is a mixture of refined rice hull and ground rice hull in equal amounts. The rice hull can be obtained as a mixture or mixed at the plant prior to its introduction to the first feed container 100.

The rice hull and calcium carbonate are then metered into a blender 104. In a preferred embodiment, 3 parts of rice hull is mixed with 7 parts of calcium carbonate. Although a ratio of 3:7 is preferred, the process can accommodate rice hull to calcium carbonate ratios of about 3:7 to about 3:2. The mixture depends upon the density (weight per cubic foot) of granules desired. The feed containers, 100 and 102, preferably contain weighing mechanisms to properly dispense controlled amounts of rice hull and calcium carbonate into the blender 104. In the blender 104, the rice hull and calcium carbonate are mixed to form a blended, homogeneous mixture, which is then transferred to one or more pin mixers 108.

In the pin mixer 108, the binder, which is diluted and stored in the binder tank 106, is added to the blended, homogeneous mixture. The pin mixer 108 thoroughly mixes the binder with the blended mixture to form granules. The binder is preferably an aqueous solution of about 35-65%, most preferably about 50%. The binder is preferably added to and mixed with the homogeneous mixture inside the pin mixer 108 by spraying the aqueous solution of the binding agent on to the mixture. The product exits the pin mixer 108 in the form of wet granules.

The wet granules are then transported from the pin mixer 108 to a pan 110, where the granules are finished by further spraying with the binding agent and rolling. The rolling process on the pan forms pellets that are prepared for the drier 112. Preferably, the pin mixer 108 and the pan 110, each contains at least one sprayer mounted thereon to facilitate the spraying process during the rolling operation. Typically, the spaying is adequate to bind the mixture forming pellets or granules. The final product preferably has about 2-8% by weight of the binder, most preferably about 3%, base upon the total weight of the product.

FIG. 1 shows a process having two pin mixers and pans; however, a similar process having a single pin mixer 108 and one pan 110 (or any other combinations) is also appropriate and is within the scope of the present invention.

The pan 110 produces wet pellets that can further be dried in a dryer system 112, preferably a drum dryer. In an embodiment of the present invention, the wet pellets are carried to the dryer by a conveyer system 116 (FIG. 1), although any method is appropriate for the present invention. The dryer 112 preferably contains heat controls that set limits required to properly dry the carrier product. Preferably, the wet pellets are dried by heated air. The air preferably enters the dryer at about 400-600° F., most preferably 450° F., and exits at about 95-110° F. The pellets or granules preferably remain in the dryer for about 15-20 minutes to completely remove the moisture. The dried product should be a hard, dry pellet which is then transported, preferably by a conveyor system, to a screening system 114 that separates the dried pellets by size. Typically, the screening system 114 separates the pellets or granules into three different sizes: 6-10 mesh, 10-14 mesh, and 14-30 mesh. The different pellet sizes are adapted to be used with different chemicals and/or materials to be carried by the carrier. For example, for chemicals and/or materials that are absorbed by the carrier, the larger pellet size is desired. On the other, if the chemicals and/or materials merely coat the carrier, the smaller pellet size is usually preferred.

Throughout the process, all discharging points in the processing system is vented and collected for recycling. For example, dust from the feed containers 102, dryer system 112, and screening system 114 is collected by the dust collector 118 and eventually recycled to the blender/mixer 104 for process efficiency and waste minimization.

The carrier is used to absorb chemicals, such as fertilizers, pesticides, herbicides, insecticides, rodenticides, and the like. Once released in the field the carrier releases the chemical in a sustained manner. Because of its light weight, the carrier of the present invention is suitable for spreading by air or conventional fertilizer applicators. Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A light weight carrier comprising rice hulls, calcium carbonate, and a binding agent.

2. The carrier of claim 1, wherein the rice hulls are present in an amount of about 27-58% by weight.

3. The carrier of claim 1, wherein the calcium carbonate is present in an amount of about 27-67% by weight.

4. The carrier of claim 1, wherein the binding agent is calcium lignosulfate.

5. The carrier of claim 1, wherein the binding agent is present in an amount of about 4-10% by weight.

6. The carrier of claim 1, where in the rice hulls is a combination of ground rice hulls and refined rice hulls.

7. The carrier of claim 6, wherein the ground rice hulls and refined rice hull are in substantially equal amounts.

8. A method for making a light weight carrier comprising the step of mixing rice hulls, calcium carbonate, and a binding agent.

9. The method of claim 8, further comprising the step of rolling the carrier into granules.

10. The method of claim 9, further comprising the step of drying the granules.

11. The method of claim 8, wherein the rice hulls are present in an amount of about 27-58% by weight.

12. The method of claim 8, wherein the calcium carbonate is present in an amount of about 27-67% by weight.

13. The method of claim 8, wherein the binding agent is calcium lignosulfate.

14. The method of claim 8, wherein the binding agent is present in an amount of about 4-10% by weight.

15. The method of claim 8, where in the rice hulls is a combination of ground rice hulls and refined rice hulls.

16. The method of claim 14, wherein the ground rice hulls and refined rice hull are in substantially equal amounts.

17. An sustained release herbicide and/or pesticide composition comprising
rice hulls,
calcium carbonate,
a binding agent, and
a herbicide and/or a pesticide.

18. The composition of claim 17, wherein the rice hulls are present in an amount of about 27-58% by weight.

19. The composition of claim 17, wherein the calcium carbonate is present in an amount of about 27-67% by weight.

20. The composition of claim 17, wherein the binding agent is calcium lignosulfate.

21. The composition of claim 17, wherein the binding agent is present in an amount of about 4-10% by weight.

22. The composition of claim 17, where in the rice hulls is a combination of ground rice hulls and refined rice hulls.

23. The composition of claim 22, wherein the ground rice hulls and refined rice hull are in substantially equal amounts.

24. A method for making a herbicide and/or pesticide composition comprising the steps of
forming a carrier by mixing rice hulls, calcium carbonate, and a binding agent; and
absorbing a herbicide and/or a pesticide into the carrier.

25. The method of claim 24, wherein the forming step further comprising rolling the carrier into granules, and drying the granules.

26. The method of claim 24, wherein the rice hulls are present in an amount of about 27-58% by weight.

27. The method of claim 24, wherein the calcium carbonate is present in an amount of about 27-67% by weight.

28. The method of claim 24, wherein the binding agent is calcium lignosulfate.

29. The method of claim 24, wherein the binding agent is present in an amount of about 4-10% by weight.

30. The method of claim 24, where in the rice hulls is a combination of ground rice hulls and refined rice hulls.

31. The method of claim 30, wherein the ground rice hulls and refined rice hull are in substantially equal amounts.
